(19) United States
(12) Patent Application Publication
(10) Pub. No.: US 2002/0198786 A1
(43) Pub. Date: Dec. 26, 2002

(54) Marketing system

(76) Inventors: Cynthia Pope Tripp, Terrace Park, OH (US); William Sampson Cole, Flower Mound, TX (US); Deborah Smith Marquardt, Cincinnati, OH (US)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 09/870,961

(22) Filed: May 30, 2001

(51) Int. Cl. G06F 17/60

(52) U.S. Cl. 705/26

(57) ABSTRACT

A method for generating a list of individuals to whom marketing efforts are to be directed comprises identifying a set of individuals (e.g., from a source database such as a data file or database storing market research data). One or more of the set of individuals are then located in a consumer database (e.g., national consumer database) to obtain data from the consumer database relating to the set of individuals. The obtained data is then analyzed to generate a model profile of the list of individuals, where the model profile identifies attributes of individuals who are likely to respond positively to the marketing efforts. For instance, the attributes may identify individuals of a particular income level, age range, or lifestyle element. The list of individuals is then generated from the consumer database using the model profile. The list of individuals may also be compared to individuals identified in a media consumption database to identify a target group of individuals, where the target group of individuals is a subset of the individuals identified in the media consumption database. Alternatively, the model profile that is generated may be applied directly to a media consumption database to generate the target group of individuals. Once this target group is identified, media consumption data associated with the target group of individuals may be obtained from the media consumption database. A media plan identifying preferable advertisement slots (e.g., temporal or spatial) within the specified media may then be generated from the obtained media consumption data.

### BACKGROUND OF THE INVENTION

1. Field of the Invention

The present invention relates to a process that enables marketing materials or advertisements to be targeted to individuals who are likely to purchase a product or service that is marketed or offered for sale. More particularly, the present invention relates to the identification of individuals to whom marketing is to be targeted as well as product and/or media consumption habits of such individuals in order to create an appropriate marketing plan.

2. Description of the Related Art

Advertising has traditionally been an important facet of maintaining and expanding product sales. In the search for increased sales, advertisements are placed in a variety of advertising media including television, radio, Internet and print (e.g., magazines, direct mail). Regardless of the medium in which products are advertised, advertising goals remain substantially the same. However, product manufacturers have realized that in order to obtain the greatest benefits from advertising efforts, it is important to target advertisements to the appropriate individuals. In order to effectively target the desired individuals, an effective marketing plan is established. For instance, advertisements for coffee might be aired during morning news programs. Although such strategies may appear obvious, the best advertising plan for a particular product may be unclear since the most valuable consumers may not be those who are consuming media in the most obvious manner.

In order to effectively achieve advertising goals, companies have traditionally sponsored expensive and time-consuming marketing efforts. Unfortunately, these marketing efforts have proven to be wasteful, since they often target individuals who are unlikely to purchase the product. For example, within a single year, a company that sends out 20 million samples to potential consumers may result in new sales and brand conversion of only 8% of the individuals targeted. Thus, in this example, 92% of the resources consumed in the marketing effort are wasted.

For any product or brand that is offered to consumers for sale, there will be a specific population who will “accept” and therefore choose to purchase a particular product or brand. For instance, through marketing research, it may be determined that 27% of households intend to purchase a particular brand of toilet paper. In the process of collecting such marketing data, various approaches have been attempted in order to identify “acceptors” of a particular product or brand. The term “acceptor” is typically used to identify an individual who will be open to a product offering or will “accept” and therefore be likely to purchase the product or brand being marketed. Likewise, the term “rejector” is often used to identify an individual who will “reject” and therefore not be likely to purchase the product or brand being marketed.

More particularly, whether an individual is an “acceptor” is often determined based upon two factors. First, the individual is interested in or open to the idea or product being marketed, and therefore has some level of “purchase intent.” Second, the person has some value to the brand. A value rating is often assigned to the individual based upon factors such as the amount of product the individual uses, the frequency with which the user consumes the product or being a new user of a brand. However, the accuracy of such categorizations of individuals as acceptors and the number of acceptors that can be identified are both limited by the approaches that have been used to target acceptors.

In one approach commonly used to identify “acceptors,” census data is collected and used to cluster households based upon geo-demographic characteristics and behavior. It is important to note that collection of census data is directed to specific groups rather than individuals or households. For instance, census data is often collected across various zip codes or postal codes. While this data can be used to model behavior in order to determine value to specific brands, this modeling is generalized across groups of people according to geographic region. Since the modeling is performed on a macro-level rather than on an individual level, this approach has limited applicability to the identification of acceptors of a product on a household level.

In another approach, surveys are used to gather consumer data. One such survey used to gather data is a “concept test.” The concept test involves describing an initiative (e.g., product being marketed). The consumer is then asked to answer various questions, such as whether they are interested in purchasing the product, the reasons for their interest or disinterest in purchasing the product, what the consumer likes/dislikes about the product, and feelings about the value of the product for the price at which the product is offered for sale. In addition, various demographics such as age, gender, income, household size, and ethnic data are also obtained.

A “concept-and-use” test follows the concept test. The concept-and-use test is, in essence, a second concept test that follows several weeks of product use. However, the amount of data that can be collected from this set of tests is limited by the questions that are presented to the consumer. Similarly, the number of acceptors that can be identified is limited by the number of tests that are performed. Accordingly, the data that can be gathered through the concept test and associated concept-and-use test is limited by the high costs associated with conducting the research. For example, this set of tests can cost over $100,000 per test and only identify less than 100 acceptors. Other methods of targeting acceptors can also include using intuition and judgment based upon qualitative research to hypothesize which marketing vehicles (e.g., direct mail lists) will target the most acceptors. This broad range of options is then validated via further research to identify the optimum marketing vehicle. This process can yield a quantity of names that identify potential acceptors. However, this process is costly and highly reliant upon the subjective judgment of specific individuals conducting the method.

Another common practice is to develop a target demographic profile based upon a single research study or database. This demographic profile is then used to obtain additional information from other available data sets. However, since this additional information is obtained at a group level rather than an individual level, this process does not achieve the desired specificity.

In an effort to expand the data that can be used for marketing purposes, a database is often accessed to obtain more detailed data for specific households or identified acceptors. However, although the data for these households may be expanded, the number of households for which data can be obtained continues to be limited by research base sizes, which are typically less than 1000 people, and research costs, which are typically approximately $50,000 for a base size of less than 500 people. Such additional databases are therefore of limited use in the expansion of research data.

Once acceptors are identified, a marketing plan is typically generated. This often involves the identification of the appropriate media (e.g., television, radio or print) and the placement of advertisements within this media. For instance, the placement of advertisements on television might involve the identification of programs or type of programs as well as time ranges within these programs. In order to identify these time slots, a media consumption database is often used to correlate media consumption patterns with groups of individuals who have been identified as acceptors. More particularly, a demographic profile corresponding to the acceptors identified from the research data is often used to access the media consumption database. For example, the profile may identify a group of individuals who are female and between the ages of 18 and 34. One example of a media consumption database is a database owned and operated by Nielsen Media Research, which contains television viewing data for selected television viewers. However, such a database contains data for a limited number of consumers. More particularly, such a database currently contains data for approximately 5000 consumers. As a result, the amount of data available to generate media plans is limited. This limitation is compounded by the fact that the number and accuracy of the acceptors identified in research efforts that are used to initiate the search in the media consumption database are also limited.

In view of the foregoing, it would be beneficial if a mechanism for more accurately identifying acceptors could be developed for marketing application. Similarly, it would be desirable if a greater number of acceptors could be identified. Moreover, it would be advantageous if such a mechanism could be used to develop a marketing plan that is appropriate for the advertising medium (e.g., print, radio, television, direct mail) that is used.

### SUMMARY OF THE INVENTION

The present invention enables the use of limited marketing research data in conjunction with preexisting sources of consumer data (e.g., consumer databases or data files) to generate more sophisticated and comprehensive profiles than would be possible using the marketing research data alone, thereby increasing the number and accuracy of acceptors that may be identified. That is, through the creation of a model profile of acceptors and the subsequent application of this model profile to such consumer databases, acceptors may be more accurately and efficiently identified, and marketing plans for placing marketing programs (e.g., advertisements) within specific media may be more effectively generated.

In accordance with a first embodiment, a method for generating a list of individuals to whom marketing efforts are to be directed comprises identifying a set of individuals (e.g., from a source database such as a database storing market research data). One or more of the individuals within the set of individuals are then located in a consumer database (e.g., national consumer database) to obtain data from this consumer database relating to the set of individuals. The obtained data is then analyzed to generate a model profile of the list of individuals, where the model profile identifies attributes of individuals who are likely to respond positively to the marketing efforts. For instance, the attributes may designate a particular income level or age range. A list of individuals is then generated from the consumer database using the model profile. This list preferably includes addresses as well as names of these individuals. In this manner, a mail file may be generated.

In accordance with another embodiment, a method for generating a target group of individuals to whom marketing efforts are to be directed for a particular media comprises obtaining a list of individuals (e.g., mail file) generated from a consumer database using a model profile as described above. The list of individuals generated from the consumer database using the model profile is then compared to individuals identified in a media consumption database to identify a target group of individuals, where the target group of individuals is a subset of the individuals identified in the media consumption database. Once this target group is identified, media consumption data associated with the target group of individuals may be obtained from the media consumption database. The media consumption data will reflect media consumption behavior of the target group of individuals and will vary with the selected media. For example, the media consumption data for television may indicate program types and specific television programs that are preferred by the target group, as well as times that the target group of individuals tends to view various television programs. A media plan identifying preferable advertisement slots (e.g., temporal or spatial) within the specified media (e.g., television, radio, or print) may then be generated from the obtained media consumption data.

In accordance with yet another embodiment, the model profile that is generated is applied directly to a media consumption database to generate the target group of individuals from the media consumption database. Media consumption corresponding to the target group may then be obtained for generation of a media plan, as described above.

These and other features of the present invention will be described in more detail below in the detailed description of the invention and in conjunction with the following figures.

### BRIEF DESCRIPTION OF THE DRAWINGS

FIG. 1 is a block diagram illustrating the generation of a mail file from a national consumer database using a model profile that was generated from the national consumer database and collected research data in accordance with a first embodiment of the invention.

FIG. 2 is a block diagram illustrating the creation of a media plan by linking a mail file such as that shown in FIG. 1 to a media consumption database in accordance with a second embodiment of the invention.

FIG. 3 is a block diagram illustrating the creation of a media plan by linking a model profile such as that shown in FIG. 1 to a media consumption database in accordance with a third embodiment of the invention.

FIG. 4 is a process flow diagram illustrating one method of generating a mail file from a national consumer database using a model profile that was generated from the national consumer database and the collected research data in accordance with the first embodiment of the invention illustrated in FIG. 1.

FIG. 5 is a process flow diagram illustrating a simplified method of creating a media plan.

FIG. 6 is a process flow diagram illustrating one method of creating a media plan by linking a mail file to a media consumption database in accordance with the second embodiment of the invention illustrated in FIG. 2.

FIG. 7 is a process flow diagram illustrating another method of creating a media plan by linking a model profile to a media consumption database in accordance with the third embodiment of the invention illustrated in FIG. 3.

FIG. 8 is a block diagram illustrating a system in which the present invention may be implemented.

### DETAILED DESCRIPTION OF THE INVENTION

In the following description, numerous specific details are set forth in order to provide a thorough understanding of the present invention. It will be obvious, however, to one skilled in the art, that the present invention may be practiced without some or all of these specific details. In other instances, well known process steps have not been described in detail in order not to unnecessarily obscure the present invention.

In accordance with one embodiment, the present invention leverages marketing research data as well as existing databases to accurately and efficiently identify individuals who are likely to respond positively to marketing efforts (e.g., acceptors or prospects who are modeled to be lookalikes to acceptors). In this manner, marketing materials or advertisements may be targeted to individuals who are likely to purchase a product or service that is marketed or offered for sale. More particularly, research data from which only crude demographic profiles might otherwise be developed may be “linked” to a preexisting database (e.g., a national consumer database) to create a more comprehensive model profile of an acceptor using the typically more detailed information from the consumer database. The model profile identifies attributes of individuals who are likely to respond positively to marketing efforts. The model profile may then be used to generate a mail file from the consumer database. In this manner, the number of acceptors that can be identified is maximized while minimizing research and marketing costs.

In addition to identifying acceptors, the present invention enables a media plan to be created for a specific media such as television, radio, Internet, or print (e.g., magazine or newspaper). For instance, a media plan may entail identifying television shows and times for advertising purposes. Media consumption databases contain data that identifies media consumption data and patterns of various individuals. One such example is a database that is owned and operated by Nielsen Media Research. While media consumption databases exist today, such media consumption databases are extremely small and contain data for only a limited number of individuals. As a result, even though acceptors may have been identified through initial research efforts, this small sample size often limits the likelihood of finding these individuals in a media consumption database.

In order to enable a media plan to be generated, the present invention leverages the information contained in a media consumption database by “linking” information that is obtained from the consumer database to a media consumption database. This may be accomplished in two ways. First, the media consumption database may be “linked” to the consumer database (e.g., national consumer database) on an individual level. More particularly, the mail file generated from the consumer database (e.g., U.S. national consumer database) may be used to identify individuals in a media consumption database. Once the individuals in the media consumption database are identified, corresponding media consumption data may be obtained. Second, the media consumption database may be “indirectly linked” to individuals in the consumer database. In other words, rather than linking the individuals contained in the consumer database to those that are contained in the media consumption database, the model profile that is generated from the consumer database is linked directly to the media consumption database based upon attributes identified in the model profile. In this manner, media consumption data (e.g., television viewing patterns) is identified that can be used to create a media plan.

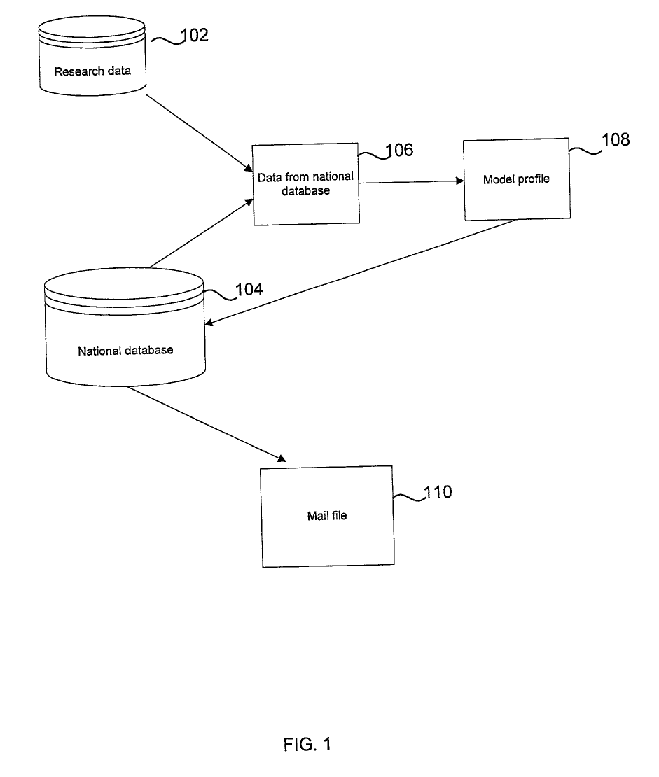

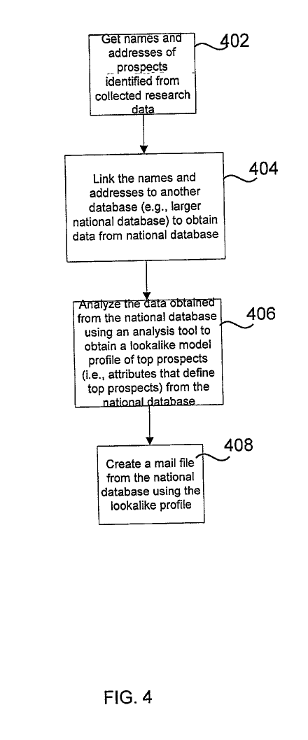

As described above, a consumer database such as a national consumer database may be used to create a model profile of an individual who is likely to respond positively to marketing efforts (i.e., acceptor), which may then be used to generate a mail file of acceptors. FIG. 1 is a block diagram illustrating the generation of a mail file from a national consumer database using a model profile that was generated from the national consumer database and collected research data in accordance with a first embodiment of the invention. As shown, a source database containing previously collected market research data 102 is “expanded” through the use of a consumer database 104 (e.g., national consumer database). This expansion is performed by identifying a set of individuals in the source database who have a high consumer potential (e.g., individuals who are likely to respond positively to marketing efforts) and obtaining data from the consumer database relating to the set of individuals. This obtained data from the national consumer database 106 is then analyzed to create a model profile 108 of acceptors. In addition, data relating to the set of individuals may also be obtained from the source database for purposes of analysis. The model profile may include a variety of information including attributes of acceptors. In other words, the model profile will identify qualities of individuals who are likely to respond positively to marketing efforts. For instance, these attributes may include demographics such as age range, gender, and income level, as well as lifestyle elements. Lifestyle elements identify information associated with an individual's lifestyle and may include, but are not limited to, ethnic data, hobbies, interests, spending, and/or consumption habits, and attitudinal data. Once the model profile 108 is obtained, it may be used to identify individuals in the national consumer database 104 who approximately satisfy the attributes in the model profile. A mail file 110 is then generated that includes the addresses and names of these identified individuals. The mail file 110 may then be used to direct advertisements and other marketing incentives to these individuals. A method of generating such a mail file is described in further detail below with reference to FIG. 4.

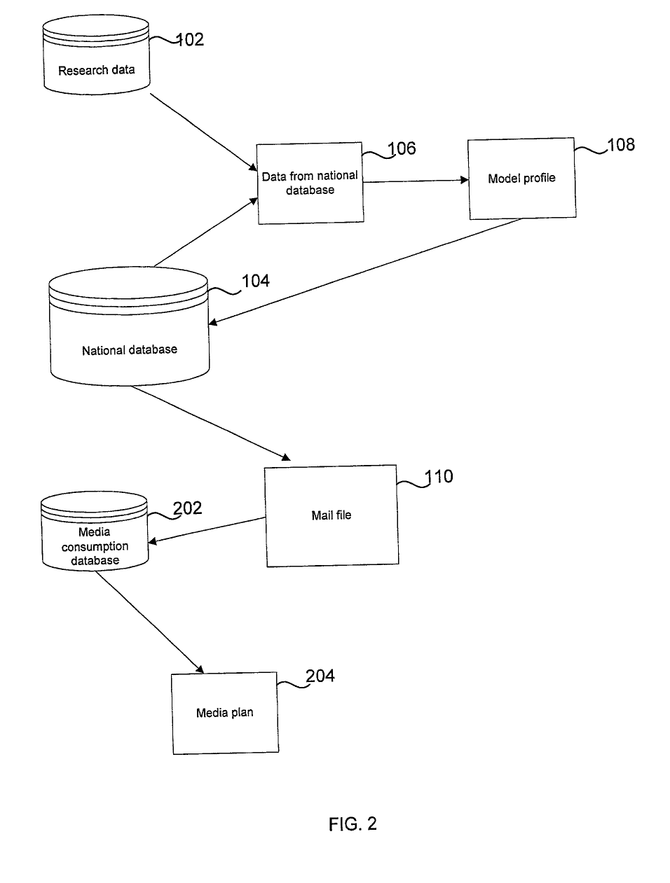

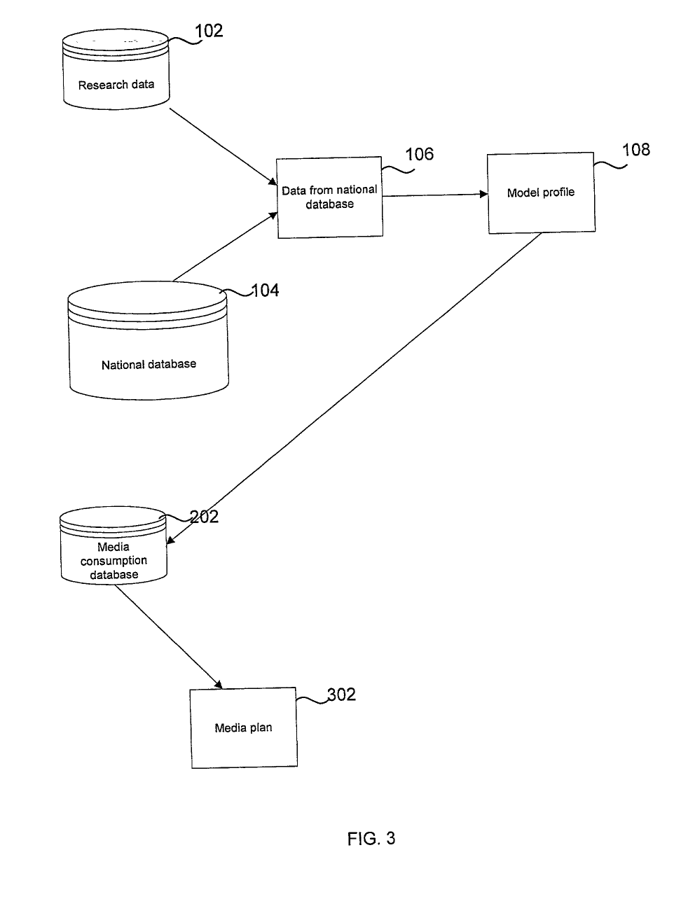

Rather than mail marketing materials to identified acceptors, a marketing group may wish to advertise via a media such as television or radio. Thus, a media plan identifying desirable advertisement slots is generated in accordance with the present invention. FIG. 2 and FIG. 3 each illustrate a different method of generating a media plan through the linking of information obtained, at least in part, from a national consumer database with that in a media consumption database.

FIG. 2 is a block diagram illustrating the creation of a media plan by linking a mail file such as that shown in FIG. 1 to a media consumption database in accordance with a second embodiment of the invention. Information obtained from the national consumer database 104 is directly “linked” with information in a media consumption database 202. More particularly, identifying information for the individuals identified in the national consumer database 104 is linked to information in the media consumption database 202. In this example, the mail file 110 is used to identify individuals in the media consumption database 202. Media consumption data for these individuals is then obtained from the media consumption database to create a media plan 204. One method of generating a media plan in accordance with the second embodiment of the invention will be described in further detail below with reference to FIG. 6.

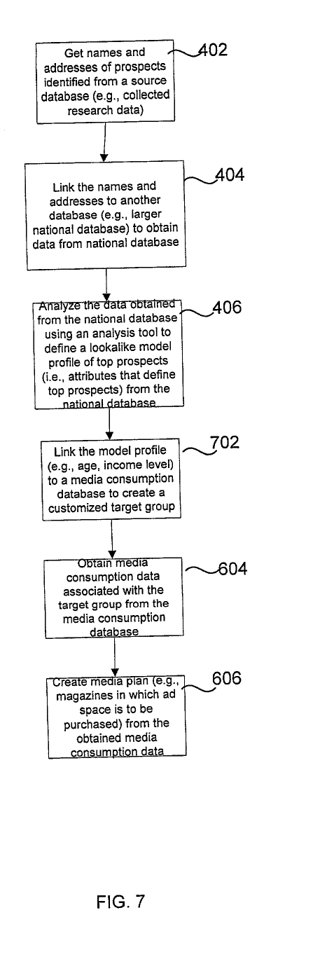

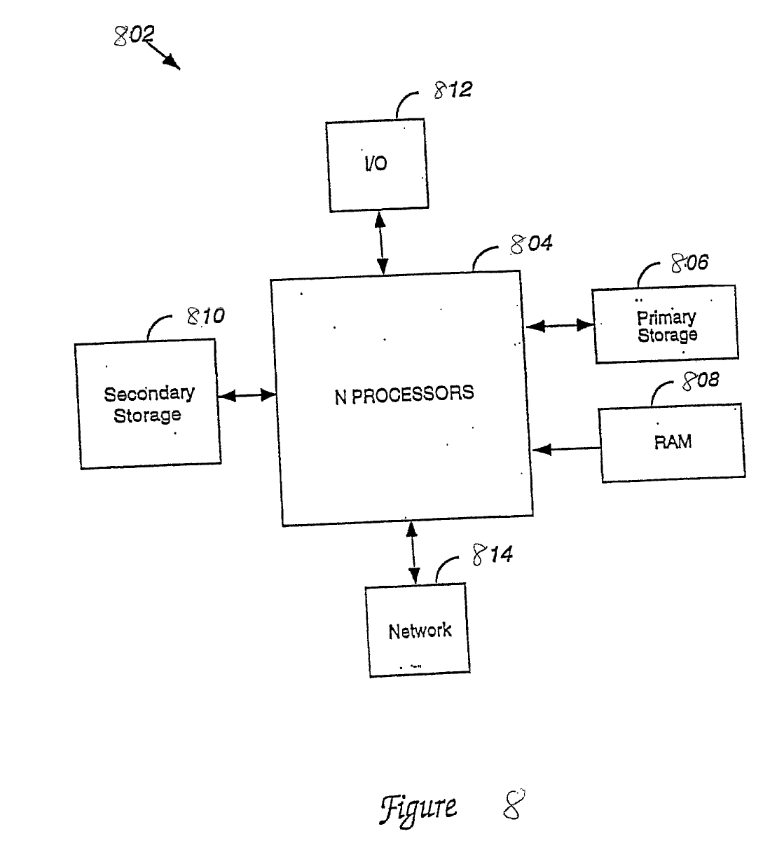

Rather than linking directly on the individual level, FIG. 3 illustrates a method of indirectly linking information obtained from the national consumer database 104 with information in the media consumption database 202. As shown, FIG. 3 is a block diagram illustrating the creation of a media plan by linking a model profile such as that shown in FIG. 1 to a media consumption database in accordance with a third embodiment of the invention. More particularly, attributes in the model profile 108 are used to obtain information from the media consumption database 202. The obtained media consumption data may then be used to create a media plan 302. One method of generating a media plan in accordance with the third embodiment of the invention will be described in further detail below with reference to FIG. 7.

FIG. 4 is a process flow diagram illustrating one method of generating a mail file from a national consumer database using a model profile that was generated from the national consumer database and the collected research data in accordance with the first embodiment of the invention illustrated in FIG. 1. As described above, the method is initiated by identifying an initial set of individuals who are desirable marketing prospects. Thus, a set of individuals from a source database is identified. More particularly, this set of individuals identifies prime prospects from previously collected market research data stored in the source database. In other words, the set of individuals may be a set of acceptors of a product for which the marketing efforts are to be directed. Since some names are common names and therefore more than one individual may share the same name, the set of individuals is preferably identified by a second piece of information such as an address (e.g., postal address or electronic mail address). Thus, as shown at block 402, a first set of names and addresses is obtained from the source database.

As described above, the research data that can be collected is limited. In order to expand on this data, the previously collected research data (e.g., stored in the source database) and the consumer database are “linked” on an individual level. In other words, one or more of the set of individuals from the source database (e.g., the first set of names and addresses) are also located in a consumer database to obtain data from the consumer database relating to the set of individuals at block 404. The data that is obtained from the consumer database may include data such as demographic data as well as other data such as lifestyle elements. As described above, lifestyle elements may include information such as hobbies, interests, spending or consumption habits, and attitudinal data. In order to expand the number of acceptors that can be identified, this consumer database is preferably larger than the source database and therefore can identify a greater number of individuals than the source database. For example, the consumer database may be a national consumer database including a plurality of postal mail addresses or an electronic mail database including a plurality of electronic mail addresses. In addition, this consumer database contains a greater amount of information related to each individual. This obtained data may then be provided to a purchaser to enable the data to be analyzed. It may therefore be desirable to store this data in a format suitable for analysis by an analysis tool. However, in order to protect the privacy of the individuals as well as the source of the data, information identifying the set of individuals from the source database is preferably removed from this data obtained from the consumer database. The obtained data therefore would not include the first set of addresses and names associated with the set of individuals from the source database. However, the obtained data could include macro-data related to geographical location (e.g., postal code, zip code, city, state). Rather than excluding the information related to the set of individuals, another alternative would be not to analyze the data related to the initial set of individuals. Moreover, in order to further maintain the privacy of the individuals, no effort is made to either include or exclude consumers identified in the initial set of individuals (e.g., source database) from the resulting marketing lists or files (e.g., mail files). Since the consumer database contains data that is more complete than data that could have been obtained from a simple survey or other research methods, the resulting data that is obtained is much more detailed than could have been obtained from initial research data.

The data obtained from the consumer database (e.g., national consumer database) is then analyzed at block 406 to generate a model profile of “top prospects.” Analysis may also include analyzing data in the source database (containing market research data) relating to the set of individuals. A variety of techniques and tools may be used to perform such analysis. For instance, regression analysis or neural network modeling may be performed to mathematically, or through artificial intelligence, predict the likelihood of an individual being an “acceptor.” Another such tool that is currently available is the CHAID (chi-squared test of statistical interaction), which seeks to identify the optimal array and sequence of variables to maximize the concentration of the targeted consumer segment. Specific applications of CHAID include Answer Tree, available from SPSS Inc., located in Chicago, Ill. and Model 1, available from Unica Technologies, located in Lincoln, Mass.

The model profile that is created from this expanded set of data is a more sophisticated, comprehensive, and directly actionable profile than could have been obtained solely from the limited research data that was initially compiled. The model profile may include a variety of information, but minimally identifies attributes of individuals who are likely to respond positively to marketing efforts. These attributes may, for example, correspond to individuals who have a high purchase intent rating indicating that the individuals are likely to purchase the product. As another example, these attributes may correspond to individuals who have a high value rating indicating that when these individuals ultimately purchase the product, they represent a high value to the company. In other words, the individuals may, for example, represent frequent purchasers and/or heavy users of the product. Thus, the attributes may identify any information that would indicate such a high purchase intent and/or value rating including, but not limited to, an age range, income level, and lifestyle elements of such “top prospects.” The model profile therefore gives a profile of an individual who is interested in purchasing the product as well as an individual who is valuable to the product brand. As described above, the model profile is defined based upon information obtained from the consumer database. In this manner, this expanded data obtained from the consumer database is studied to identify “lookalikes” for marketing purposes.

A list of “top prospects” is then generated from the consumer database using the model profile at block 408. More particularly, the model profile is applied to the consumer database such that individuals who approximately satisfy the attributes in the model profile are identified. The list of “top prospects” to whom marketing efforts are to be directed therefore identifies the individuals who approximately satisfy the attributes in the model profile. In addition, the list preferably includes addresses of the individuals such as postal or electronic mail address to enable marketing materials to be sent to the individuals. In this manner, a mail file may be generated from a database such as a national consumer database using a “lookalike” model profile.

As described above, the list of “top prospects” is generated through a modeling process based upon previously identified consumers (e.g., acceptors). As defined above, an acceptor is an individual who will be open to a product (or service) offering or who will “accept” and therefore be likely to purchase the product, brand, or service being marketed. Thus, a top prospect is also likely to be open to a product, brand, or service offering and therefore is also likely to purchase the product, brand, or service being marketed.

Rather than send marketing materials to individuals, it may be desirable to advertise on a broader level to a group of individuals. Such advertisements may be broadcast or otherwise distributed via a variety of media including, but not limited to, radio, television, and print media such as magazines and newspapers. Regardless of the media, a media plan for creating and distributing such advertisements is often created. In this manner, a company or marketing group can ensure that the advertisements reach the greatest number of acceptors.

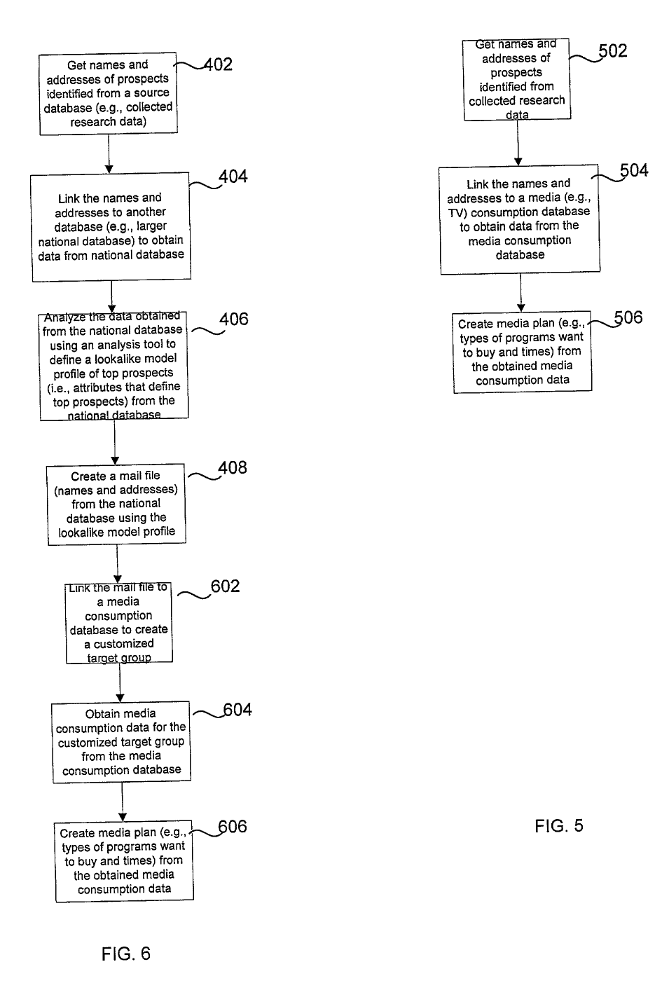

FIG. 5 is a process flow diagram illustrating a simplified method of creating a media plan. In order to create a media plan, it is first necessary to identify the target group of individuals. An ideal starting point for identifying a group of acceptors is previously collected research data. As shown at block 502, information including names and addresses of prime prospects identified from collected research data may be obtained, as described above. In order to determine the media consumption patterns of these prime prospects, a media consumption database that stores such information may be accessed. For example, a database that is owned and operated by Nielsen Media Research may be accessed to determine television programs and program types that the group of acceptors views. Other media consumption databases will be described below with reference to FIG. 6. Thus, as shown at block 504, the names and addresses obtained from the collected research data may be used as a “link” to the appropriate media consumption database to obtain media consumption data for the previously identified acceptors. A media plan corresponding to this information may then be created at block 506. For example, the types of programs that are desirable for placement of advertisements and times within these programs may be selected. While this three-step process appears to be complete, there are two disadvantages. First, the original group of acceptors that is identified from the collected research data is limited by the size of the research sample. Thus, the data that can be gathered from the media consumption database is limited. Second, a media consumption database such as the Nielsen database is also often limited in size since the number of individuals for which data has been gathered is limited. Two improved methods for creating a media plan are described in further detail below with reference to FIG. 6 and FIG. 7.

FIG. 6 is a process flow diagram illustrating one method of creating a media plan by linking a mail file to a media consumption database in accordance with the second embodiment of the invention illustrated in FIG. 2. The media consumption database that is selected will vary with the media in which advertisements are to be placed. More particularly, media consumption databases that are currently available as sources for media consumption data include the Arbitron database, Nielsen Media Research Data, and the print media readership database available from Mediamark Research, Inc. (MRI) for radio, television, and print media, respectively. More particularly, a media consumption database that includes television or radio consumption data may identify types of programs, specific programs, program times and/or time ranges. Similarly, print consumption data may identify types of magazines, specific magazines, newspapers and/or other publications.

As shown in FIG. 6, a list of individuals (e.g., mail file) that approximately satisfy attributes of an acceptor is generated from a database as described above with reference to blocks 402 through 408 of FIG. 4. In this manner, the number of acceptors for which data can be gathered is expanded through a larger set of data (e.g., database). This mail file is then “linked” to a media consumption database to create a customized target group (i.e., target audience) as shown at block 602. This “linking” is performed on an individual level. More particularly, one or more individuals in the target group are identified in the media consumption database. In other words, the list of individuals identified in the larger database from the model profile is compared to individuals identified in the media consumption database to identify a target group of individuals. In this manner, a subset of the individuals in the media consumption database is identified. Since the number of acceptors in the generated list is greater than the number of individuals originally identified through initial research efforts, the number of individuals who will be identified in the media consumption database will be increased. Similarly, the likelihood of identifying individuals in the media consumption database will also be increased. Media consumption data associated with the target group of individuals is then obtained from the media consumption database at block 604. More particularly, media consumption data for those individuals in the target group who were identified in the media consumption database is obtained. For example, the media consumption data may indicate the type of programs that the target group of individuals prefers to watch. Thus, media consumption data stored in the media consumption database may identify media consumption patterns of the individuals identified in the media consumption database. In this manner, a media consumption pattern (e.g., television viewing habits) of the target group of individuals may be ascertained from the obtained media consumption data.

A media advertising plan is then created at block 606 from the obtained media consumption data. More particularly, the media advertisement plan indicates a preferred placement (e.g., spatial or temporal) of one or more advertisements within specified media (e.g., magazine or television). As described above, the obtained media consumption data will vary with the selected media and media consumption database. Similarly, the media advertising plan created from the obtained media consumption data will vary. As one example, an advertising plan for television or radio may identify the type of program, program and/or time during which advertising time is to be purchased. As another example, an advertising plan for print media may identify a type of magazine, magazine name, newspaper name and/or other publication in which advertising space is to be purchased. In this manner, a specific plan for purchasing advertisement slots directed to the target group is created.

FIG. 7 is a process flow diagram illustrating another method of creating a media plan by linking a model profile to a media consumption database in accordance with the third embodiment of the invention illustrated in FIG. 3. A model profile identifying attributes of individuals who are likely to respond positively to the marketing efforts is generated as described above with reference to blocks 402 through 406 of FIG. 4. The model profile is then applied to a media consumption database at block 702 to generate a target group of individuals to whom marketing efforts are to be directed for the selected media. More particularly, the media consumption database is searched for individuals who approximately satisfy the attributes identified in the model profile. For example, the attributes may indicate demographics (e.g., age range and gender) and/or other lifestyle elements of individuals who are predicted to be “top prospects.” Thus, the media consumption database is searched for individuals of this age range and/or income level. Once this target group of individuals is identified, media consumption data associated with the target group of individuals is obtained from the media consumption database as described above with reference to block 604. A media advertising plan is then created from the obtained media consumption data as described above with reference to block 606. A model profile therefore becomes a valuable tool for searching a media consumption database. Accordingly, household data represented in a media consumption database is linked indirectly (e.g., via demographic group) rather than on an individual level with a database such as a national consumer database.

The present invention may be implemented on any suitable computer system. FIG. 8 illustrates a typical, general-purpose computer system 802 suitable for implementing the present invention. The computer system may take any suitable form. For example, the computer system may be integrated with a digital television receiver or set top box.

The computer system 802 includes any number of processors 804 (also referred to as central processing units, or CPUs) that may be coupled to memory devices including primary storage device 806 (typically a read only memory, or ROM) and primary storage device 808 (typically a random access memory, or RAM). As is well known in the art, ROM acts to transfer data and instructions uni-directionally to the CPUs 804, while RAM is used typically to transfer data and instructions in a bi-directional manner. Both the primary storage devices 806, 808 may include any suitable computer-readable media. The CPUs 804 may generally include any number of processors.

A secondary storage medium 810, which is typically a mass memory device, may also be coupled bi-directionally to CPUs 804 and provides additional data storage capacity. The mass memory device 810 is a computer-readable medium that may be used to store programs including computer code, data, and the like. Typically, the mass memory device 810 is a storage medium such as a hard disk which is generally slower than primary storage devices 806, 808.

The CPUs 804 may also be coupled to one or more input/output devices 812 that may include, but are not limited to, devices such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, the CPUs 804 optionally may be coupled to a computer or telecommunications network, e.g., an internet network or an intranet network, using a network connection as shown generally at 814. With such a network connection, it is contemplated that the CPUs 804 might receive information from the network, or might output information to the network in the course of performing the above-described method steps. Such information, which is often represented as a sequence of instructions to be executed using the CPUs 804, may be received from and outputted to the network, for example, in the form of a computer data signal embodied in a carrier wave.

Various embodiments of the invention can also be embodied as computer readable code on a computer readable medium. The computer readable medium is any data storage device that can store data which can thereafter be read by a computer system. Examples of the computer readable medium include read-only memory, random-access memory, CD-ROMs, magnetic tape, and optical data storage devices.

Although illustrative embodiments and applications of this invention are shown and described herein, many variations and modifications are possible which remain within the concept, scope, and spirit of the invention, and these variations would become clear to those of ordinary skill in the art after perusal of this application. For instance, the present invention is based upon the generation of a mail file and/or media plan using various databases, including national and media consumption databases. However, it should be understood that the present invention is not limited to this arrangement, but instead would equally apply regardless of the source of the data. For example, the identification of an initial set of individuals may be performed from a file or list (e.g., printed list) rather than a database. Moreover, a media consumption database may include a variety of information and is therefore not limited to that related to television, radio and print media. Accordingly, the present embodiments are to be considered as illustrative and not restrictive, and the invention is not to be limited to the details given herein, but may be modified within the scope and equivalents of the appended claims.

What is claimed is:

1. A method for generating a model profile using an initial list of consumer names identifying marketing prospects, the method comprising:
using the initial list of consumer names to obtain initial consumer data from a database, the initial consumer data including data corresponding to each of selected ones of the list of consumer names; and
processing the initial consumer data to generate the model profile.

2. The method of claim 1, further comprising using the model profile to retrieve additional consumer data from the database, the additional consumer data corresponding to a second list of consumer names and corresponding contact information.

3. A list generated from model profile of claim 1, the list including a second list of consumer names and corresponding contact information.

4. The method of claim 1 wherein the initial consumer data is not identified by any of the initial list of consumer names.

5. The method of claim 1, where in the initial consumer data identifies at least one of demographics, hobbies, interests, spending habits, consumption habits, and attitudinal data.

6. The method of claim 1, wherein the model profile identifies at least one of demographics, hobbies, interests, spending habits, consumption habits, and attitudinal data.

7. The method of claim 2, wherein the additional consumer data identifies at least one of demographics, hobbies, interests, spending habits, consumption habits, and attitudinal data.

8. A method for generating a list of individuals to whom marketing efforts are to be directed, the method comprising:
identifying a set of individuals who are top marketing prospects;
locating one or more of the set of individuals in a consumer database to obtain data from the consumer database relating to the set of individuals;
analyzing the obtained data to generate a model profile of the list of individuals, the model profile identifying attributes of individuals who are likely to respond positively to the marketing efforts; and
generating the list of individuals from the consumer database using the model profile.

9. The method as recited in claim 8, wherein analyzing the obtained data to generate a model profile comprises:
analyzing the obtained data and data in a source database relating to the set of individuals.

10. The method as recited in claim 8, wherein analyzing the obtained data comprises performing statistical analysis.

11. The method as recited in claim 8, wherein the attributes correspond to individuals who have a high purchase intent rating.

12. The method as recited in claim 8, wherein the attributes correspond to individuals who have a high value rating.

13. The method as recited in claim 8, wherein the attributes correspond to individuals who have high potential as consumers to a particular brand or product.

14. The method as recited in claim 8, wherein identifying a set of individuals comprises:
identifying a set of acceptors of a product for which the marketing efforts are to be directed.

15. The method as recited in claim 8, wherein identifying a set of individuals comprises identifying a set of individuals from a source database, the source database including collected market research data relating to the set of individuals.

16. The method as recited in claim 8, wherein the consumer database is a national consumer database including a plurality of postal mail addresses.

17. The method as recited in claim 8, wherein the consumer database is a database including a plurality of email addresses.

18. The method as recited in claim 8, wherein the list of individuals generated from the consumer database includes a generated set of addresses and wherein identifying the set of individuals comprises:
obtaining a source set of addresses and names.

19. The method as recited in claim 18, wherein locating one or more of the set of individuals in a consumer database comprises:
locating at least a portion of the generated set of addresses and names in the consumer database.

20. The method as recited in claim 19, wherein the data obtained from locating one or more of the set of individuals in the consumer database does not include the source set of addresses and names associated with the set of individuals.

21. The method as recited in claim 8, wherein the data obtained from locating one or more of the set of individuals in the consumer database does not identify one or more of the set of individuals.

22. The method as recited in claim 8, wherein generating the list of individuals from the consumer database using the model profile comprises:
applying the model profile to the consumer database such that individuals who approximately satisfy the attributes in the model profile are identified; and
creating the list of individuals from the consumer database, the list of individuals including individuals identified by applying the model profile to the consumer database and including a plurality of associated addresses.

23. The method as recited in claim 8, wherein the consumer database is larger than a source database from which the set of individuals is identified.

24. The method as recited in claim 8, wherein the consumer database identifies a greater number of individuals than a source database from which the set of individuals is identified.

25. The method as recited in claim 8, wherein the attributes include at least one of age range, income level, and lifestyle element.

26. A list of individuals generated by the method of claim 8.

27. A method for generating a set of data for use in identifying individuals to whom marketing efforts are to be directed, the method comprising:
identifying a set of individuals from a source database including collected market research data relating to the set of individuals.
locating one or more of the set of individuals in a consumer database to obtain data from the consumer database relating to the set of individuals;
removing identifying information from the obtained data, the identifying information including information that identifies one or more of the set of individuals; and
providing the obtained data to enable the obtained data to be analyzed.

28. A method for generating a list of individuals to whom marketing efforts are to be directed, the method comprising:
receiving data that includes attributes obtained from a consumer database, the attributes being associated with individuals identified in a source database;
analyzing the obtained data to generate a model profile of the list of individuals, the model profile being defined by attributes of individuals who are likely to respond positively to the marketing efforts;
applying the model profile to the consumer database such that individuals who correspond to at least some of the attributes in the model profile are identified; and
generating the list of individuals from the consumer database, the list of individuals identifying the individuals who correspond to at least some of the attributes in the model profile and including contact information for each of the individuals.

29. A list of individuals generated by the method of claim 28.

30. A method for generating a target group of individuals to whom marketing efforts are to be directed for a particular media, the method comprising:
locating one or more of a set of individuals in a consumer database to obtain data from the consumer database relating to the set of individuals;
analyzing the obtained data to generate a model profile of the list of individuals, the model profile identifying attributes of individuals who are likely to respond positively to the marketing efforts;
generating the list of individuals from the consumer database using the model profile; and
comparing the list of individuals generated from the consumer database using the model profile to individuals identified in a media consumption database to identify a target group of individuals, the target group of individuals being a subset of the individuals identified in the media consumption database.

31. The method as recited in claim 30, further comprising:
identifying the set of individuals from a source database.

32. The method as recited in claim 30, further comprising:
obtaining media consumption data associated with the target group of individuals from the media consumption database; and
creating a media advertising plan from the obtained media consumption data, the media advertisement plan indicating a preferred placement of one or more advertisements within the media.

33. The method as recited in claim 32, wherein the placement is spatial.

34. The method as recited in claim 32, wherein the placement is temporal.

35. The method as recited in claim 32, further comprising:
identifying a media consumption pattern of the target group of individuals from the obtained media consumption data; and
generating the media advertising plan from the identified media consumption pattern.

36. The method as recited in claim 30, wherein the media consumption database identifies media consumption patterns of the individuals identified in the media consumption database.

37. The method as recited in claim 30, wherein the media is television and the media consumption database includes television consumption data of the individuals identified in the media consumption database.

38. The method as recited in claim 37, wherein the television consumption data identifies at least one of type of program, program, program time, and time range of one or more television programs viewed by the individuals identified in the media consumption database.

39. The method as recited in claim 37, wherein the media advertising plan identifies at least one of type of program, program and time during which advertising time is to be purchased.

40. The method as recited in claim 30, wherein the media is radio and the media consumption database includes radio consumption data of the individuals identified in the media consumption database.

41. The method as recited in claim 40, wherein the radio consumption data identifies at least one of type of program, program, program time, and time range listened to by the individuals identified in the media consumption database.

42. The method as recited in claim 40, wherein the media advertising plan identifies at least one of type of program, program and time during which advertising time is to be purchased.

43. The method as recited in claim 30, wherein the media is a print media and the media consumption database includes print consumption data of the individuals identified in the media consumption database.

44. The method as recited in claim 43, wherein the print consumption data identifies at least one of type of magazine, magazine name, name of newspaper, and name of publication read by the individuals identified in the media consumption database.

45. The method as recited in claim 43, wherein the media advertising plan identifies at least one of type of magazine, specific magazine, and newspaper in which advertising space is to be purchased.

46. The method as recited in claim 30, wherein the media is the Internet.

47. A method for generating a target group of individuals to whom marketing efforts are to be directed for a particular media, the method comprising:
receiving data that includes attributes obtained from a consumer database, the attributes being associated with individuals identified in a source database;
analyzing the obtained data to generate a model profile of the list of individuals, the model profile being defined by attributes of individuals who are likely to respond positively to the marketing efforts;
applying the model profile to the consumer database such that individuals who approximately satisfy the attributes in the model profile are identified;
generating the list of individuals from the consumer database using the model profile, the list of individuals including a plurality of associated addresses; and
comparing the list of individuals generated from the consumer database using the model profile to individuals identified in a media consumption database to obtain a target group of individuals, the target group of individuals being a subset of the individuals identified in the media consumption database.

48. The method as recited in claim 47, further comprising:
obtaining media consumption data associated with the target group of individuals from the media consumption database; and
creating a media advertising plan from the obtained media consumption data.

49. The method as recited in claim 48, further comprising:
identifying a media consumption pattern of the target group of individuals from the obtained media consumption data; and
generating the media advertising plan from the identified media consumption pattern.

50. A method for generating a target group of individuals to whom marketing efforts are to be directed for a particular media, the method comprising:
identifying a set of individuals;
locating one or more of the set of individuals in a consumer database to obtain data from the consumer database relating to the set of individuals;
analyzing the obtained data to generate a model profile of the target group of individuals, the model profile identifying attributes of individuals who are likely to respond positively to the marketing efforts; and
applying the model profile to a media consumption database to generate the target group of individuals, the target group of individuals being a subset of individuals identified in the media consumption database.

51. The method as recited in claim 50, wherein identifying a set of individuals comprises identifying a set of individuals from a source database.

52. The method as recited in claim 50, wherein applying the model profile to the media consumption database to generate the target group of individuals comprises:
searching the media consumption database for individuals who approximately satisfy the attributes identified in the model profile.

53. The method as recited in claim 50, further comprising:
obtaining media consumption data associated with the target group of individuals from the media consumption database; and
creating a media advertising plan from the obtained media consumption data.

54. The method as recited in claim 53, further comprising:
identifying a media consumption pattern of the target group of individuals from the obtained media consumption data; and
generating the media advertising plan from the identified media consumption pattern.

55. A method for generating a target group of individuals to whom marketing efforts are to be directed for a particular media, the method comprising
receiving data that includes attributes obtained from a consumer database, the attributes being associated with individuals identified in a source database;
analyzing the obtained data to generate a model profile of the target group of individuals, the model profile being defined by attributes of individuals who are likely to respond positively to the marketing efforts; and
applying the model profile to a media consumption database such that the target group of individuals is identified, the target group of individuals approximately satisfying the attributes in the model profile.

56. The method as recited in claim 55, wherein the attributes include at least one of age range, income level, and lifestyle element.

57. The method as recited in claim 55, further comprising:
obtaining media consumption data associated with the target group of individuals from the media consumption database; and
creating a media advertising plan from the obtained media consumption data.

58. The method as recited in claim 57, further comprising:
identifying a media consumption pattern of the target group of individuals from the obtained media consumption data; and
generating the media advertising plan from the identified media consumption pattern.

59. A computer-readable medium storing thereon instructions for generating a list of individuals to whom marketing efforts are to be directed, the computer-readable medium comprising:
instructions for identifying a set of individuals who are top marketing prospects;
instructions for locating one or more of the set of individuals in a consumer database to obtain data from the consumer database relating to the set of individuals;
instructions for analyzing the obtained data to generate a model profile of the list of individuals, the model profile identifying attributes of individuals who are likely to respond positively to the marketing efforts; and
instructions for generating the list of individuals from the consumer database using the model profile.

60. An apparatus for generating a list of individuals to whom marketing efforts are to be directed, comprising:
a processor; and
a memory, at least one of the processor and the memory being adapted for performing the following steps:
identifying a set of individuals who are top marketing prospects;
locating one or more of the set of individuals in a consumer database to obtain data from the consumer database relating to the set of individuals;
analyzing the obtained data to generate a model profile of the list of individuals, the model profile identifying attributes of individuals who are likely to respond positively to the marketing efforts; and
generating the list of individuals from the consumer database using the model profile.

61. An apparatus for generating a list of individuals to whom marketing efforts are to be directed, comprising:
means for identifying a set of individuals who are top marketing prospects;
means for locating one or more of the set of individuals in a consumer database to obtain data from the consumer database relating to the set of individuals;
means for analyzing the obtained data to generate a model profile of the list of individuals, the model profile identifying attributes of individuals who are likely to respond positively to the marketing efforts; and
means for generating the list of individuals from the consumer database using the model profile.
